(19) United States
(12) Patent Application Publication
(10) Pub. No.: US 2004/0107850 A1
(43) Pub. Date: Jun. 10, 2004

(54) Attachable wall or surface push button marking device

(76) Inventor: Anthony Shane Hughes, Eastpointe, MI (US)

Correspondence Address: ANTHONY S. HUGHES SR., 23133 FIRWOOD, EAST POINTE, MI, 48021, US

(21) Appl. No.: 10/315,256

(22) Filed: Dec. 10, 2002

(51) Int. Cl. B41K 1/38; B41F 31/00

(52) U.S. Cl. 101/327

(57) ABSTRACT

A marking assembly for use with any stud sensor or a surface of other objects, which the person wishes to make a mark on.

In the assembly embodiment, an upper and lower housing which houses two wire wound springs, two plastic pivot levers, two plastic link levers, a cartridge holder which is used to hold either and ink cartridge which can be washable ink or permanent ink or it can hold a chalk, toner, or powdered lead cartridge which is refillable by the user.

Located on the outside of the upper housing is a button which is connected to a metal clock spring also to be located on the upper housing at which all are connected to the upper housing by metal pins running through aligned holes in the button, the upper housing, and the two plastic push levers which were mentioned above. The assembly also has a plastic cap which fits onto the top top and that us used to cover the cartridge holder and all or the inside components.

The Stud-Marker is an assembly that consist of 16 parts, which are broken up into the following components, (See FIG. 8) Component (A) upper housing (1 needed), Component (B) Plastic custom molded button (1 needed), Component (C) Plastic molded lower housing (1 needed), Component (D) FIG. 3) is a stud sensor for reference only, Component (E) is a thin rubber diaphragm (1 needed), Component (F) spring (4 needed), Component (G) Metal screw (4 needed), Component (H) thin hairs assembled to make what is to be know as a powder applicator (1 needed), The letter (1) is not used for clarity, Components (J) (K), & (L) are a thin piece of two sided foam sticky tape cut to length. (1 of each needed)

### FIELD OF THE INVENTION

This invention is related to handheld stud sensing devices. This invention is a unit, which can be molded into the housing of current stud finders or can be molded as a separate unit that can be added to a stud finder by the use of 2 sided sticky foam strips. This invention is a device that leaves a center mark onto any surface where a person wishes to put in a screw or any other fastening device without the need for a pencil thus making this a one handed operated device.

### REFERENCED OR RELATED MATERIALS

| | | |
|---|---|---|
| 1529293 | March 1925 | Beulwitz 33/678. |
| 2575354 | November 1951 | Mills 33/767. |
| 2581858 | January 1952 | Hilt et al. 33/768. |
| 2624120 | January 1953 | Mills 33/668. |
| 3205584 | September 1965 | Overaa 33/760. |
| 3731389 | May 1973 | King 33/189. |
| 4015337 | April 1977 | Taylor 33/138. |
| 4296554 | October 1981 | Hammerstrom 33/138. |
| 4439927 | April 1984 | Elliott 33/189. |
| 4542589 | September 1985 | Yamamoto 33/138. |
| 4580347 | April 1986 | McKnight 33/138. |
| 4630376 | December 1986 | Pentecost 33/138. |
| 4667412 | May 1987 | Carlson 33/138. |
| 4700489 | October 1987 | Vasile 33/342. |
| 4729171 | March 1988 | Samson 33/138. |
| 4827622 | May 1989 | Makar 33/770. |
| 4965941 | October 1990 | Agostinacci 33/668. |
| 5416978 | May 1995 | Kaufman 33/770. |
| 5435074 | July 1995 | Holevas et al. 33/668. |
| 5477619 | December 1995 | Kearns 33/668. |
| 5809662 | September 1998 | Skinner 33/768. |
| 5829152 | November 1998 | Potter et al. 33/668. |
| 6041513 | March 2000 | Doak 33/668. |

Foreign Patent Documents

| | | |
|---|---|---|
| 2172109A | September 1986 | GB. |
| 63-212801 | September 1988 | JP. |

### STATEMENT OF FEDERALLY SPONSORED RESEARCH/DEVELOPMENT

This was invented by a small entity and was not sponsored by the government or any other agency

### REFERENCE OR SEQUENSE LISTING

Not applicable

### BACKGROUND OF THE INVENTION

This invention relates to a marking device which can be attached to any stud sensor.

Stud sensors a used primarily for locating a stud or any electrical wires behind a wall. Once the stud or other objects are located, the person uses a pen or pencil to make a mark on the surface to mark the desired location for a screw or a nail.

This invention solves the need for a use of a pen or pencil by allowing the person to make a mark on the surface by pulling the button rearward and allowing this marking system to leave a thin mark on the surface to mark the desired location for a screw or a nail.

This invention also solves the problem of needing the use of two hands for the sensing and marking process. This is because the person can now hold the stud sensing device with one hand and place a mark in the desired location by activating the button on the marking system with one finger on the same hand. This allows the person to have their other hand free and also allows a person to obtain better balance in hard to locate and mark situations.

### SUMMARY OF THE INVENTION

It is an object of the present invention which is to provide a new way to make a mark on a surface using either ink, chalk, paint, lead, or toner.

It is also an object of the present invention to provide a marking system which can be attached to a stud sensor or to any other surface of an object which the person wishes to place a mark.

According to one feature of the present invention, There is provided a separate ink cartridge which can be used to make a mark until the ink runs out and then the person can replace the said ink cartridge.

Also, according to another feature of the present invention, There is a cartridge which can be used on this assembly which will allow the user to use chalk for the method of marking a surface by attaching the cartridge to this assembly and removing the top cap of the chalk cartridge and adding powdered chalk into the drum of the chalk cartridge, then replacing the cap onto the top of the chalk cartridge to seal the chalk inside.

The principal benefit of this invention is that once attached to any stud sensor or surface of any object which the person wishes to make a make on, the mark can be added with just a one fingered movement on one hand.

Additional objects, features, aspects, and advantages of the present invention will be set forth, in part, in the description which follows and, in part, will be obvious from the description or may be learned by practice of the invention. In the description, reference is made to the accompanying drawings which form a part thereof and in which is shown by way of illustration specific embodiments for practicing the invention. These embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF DRAWINGS

The accompanying drawings, which are hereby incorporated into and constitute a part of this specification, illustrate preferred embodiments of the invention and, together with the description serve to explain the principles of the invention. In the drawings wherein like reference numerals represent like parts:

FIG. 1 is an exploded view showing all separate components of the assembly in which this invention is related to.

FIG. 2 is showing the incorporation of the said invention also to be known as the Stud Marker to a generic referenced only stud sensor. Part (A) which is the top illustration shows a stud sensor separated from the “StudMarker” Part (B) which is the bottom illustration shows the “StudMarker” attached to a referenced only stud sensing device. In the correct working location.

FIG. 3 is showing two side views of a section cut through the assembly of this invention. Part (A) which is the top illustration is showing this related invention attached to a generic referenced only stud sensor in the before activation position thus showing the button in the forward down position and the marker assembly in the up position inside the housing. Part (B) which is the bottom illustration is showing this related invention attached to a generic referenced only stud sensor after activation thus showing the button pulled rearward and the marker assembly in the down position.

FIG. 4 is showing three isometric views of this inventions assembly connected to a generic referenced only stud sensing device as to how a person would place a mark on a surface. This figure is separated into three parts. Part(A) which is the top illustration is showing this invention attached to a generic stud sensor and placed onto a reference only surface and is before activation of this inventions assembly. Part(B) which is the center illustration is showing this invention attached to a generic stud sensor and placed onto a reference only surface with the button in the rearward activation position. Part (C) which is the bottom illustration is showing this invention attached to a generic stud sensor and showing the above mentioned assembly lifted away from surface and a cross line mark left on that surface thus indicating the desired location to place a screw or nail.

FIG. 5 is showing a side section cut view of the disposable ink cartridge assembly (part M)

FIG. 6 is showing a side section cut view of the reusable powdered chalk/toner/or lead cartridge (part Q)

### DETAILED DESCRIPTION OF DRAWINGS

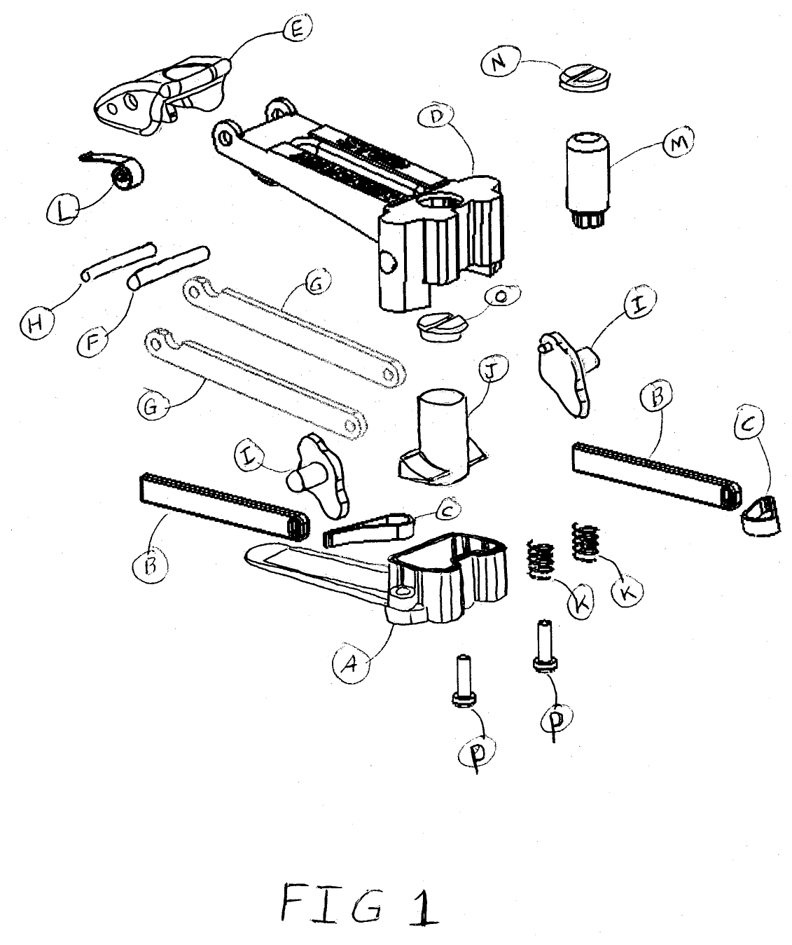

FIG. 1 is showing an exploded view of all components of this invention. Part (A) is the lower housing of this assembly that houses all components. This is to be made out of plastic.

Part (B) is a side attachment used to attach this invention to any existing stud sensor. This is a plastic strip in which there can be an adhesive strip added to it. It has an elongated slot towards the front of the component that is used to string part (C) that is a flexible piece of material that is used to connect the plastic side attachment to the rest of the assembly. There is two pieces required for this invention.

Part (C) is an adjustable strap with Velcro attached to allow for user-defined settings.

Part (D) is the upper housing of this assembly that houses all components. This is to be made out of plastic. This component also has an area for the button (part E) to attach to by using a metal pin (part F), which allows the button (part E) to pivot.

Part (E) is the button used to activate the assembly of this invention. This part is to be made out of plastic. This component has two holes located through the side of the entire part, which are to be used as follows: One hole which is the larger hole located in the forward area of the component is used to align this part with the upper housing (Part D) And allowing this component to pivot around this area by using a metal pin (part F) which slides through the side of this part and the hole located in the rear end of the upper housing Part (D).

Part (F) is a metal pin used to assemble the button (part E) to the upper housing (part D) and allow the button (part E) to pivot.

Part (G) is a plastic push lever in which 2 are required for this assembly and is used to attach the button (part E) to the pivot levers (part I) for activation of the assembly) At one end there is a half round notch cutout which is used to provide clearance for the pivoting pin (part F) this end also has a hole located through it at the end which is used to align to the rearward hole in the button (part E) which both are attached by using a metal pivoting pin (part H)

Part (H) is a metal pin used to attach both of the plastic push levers (parts G) to the rearward hole of the button (part E)

Part (I) is a plastic pivot lever. There are two of these required for this assembly and are to be located symmetrically across from each other about the centerline fwd to rear direction. There are two bosses extruded one on each side. There is a large extruded boss on one side located in the center of the component. This boss is used to align with a hole in the upper housing that will allow the pivot lever to pivot upon. The second extruded boss, which is located on the opposite side of the larger center plastic boss, is located on a protruded upper wing of the pivot lever, and is used to attach the push lever (part G) to. Once the button (part E) is activated, the push levers (parts G) move to the forward position and pushes on the smaller inside bosses of the upper part of the pivot lever thus pushing it to the forward position. This causes the lower part of the pivot lever to rotate rearward. The lower side of the pivot lever aligns with a wing which is located one on each side about the symmetry line on the lower side of the cartridge holder (part I) which the two pivot levers then push down onto the wings of the cartridge holder (part J) thus making a mark.

Part (J) is a cartridge holder. This is used primarily to hold a choice of the ink cartridge (part M) or the chalk/toner/powdered lead holder (part Q) inside. Each cartridge is locked into position by screwing the cartridge holder cap (part N) onto the cartridge holder once the cartridge is in place. This component has two wings that are located on the outside lower part of the body. Each are located opposite from each other right and left side symmetrically along the centerline. These wings are to have a curved surface, which curves from the lower side in the forward area to the upper side to the rear a set distance. This is used to allow each lower side of the pivot levers (part I) to align with and ride along when the pivot levers are rotated from front to rear.

Part (K) is a metal wire wound push spring which two are required for this assembly. These springs are to be located on the lower housing and each are to be aligned with the bottom side of each wing on the cartridge holder (part J) and are used to push the cartridge holder back into the up position once the unit is finished activating and leaving a mark onto a surface.

Part (L) is a metal flat wound clock spring which is to be located in a pocket inside the rearward under position of the upper housing (part D) and is to have one end which is to align on the under side of the button (part E). This component is to push the button (Part E) back into the start position, which then pulls the push levers (parts G) back into position.

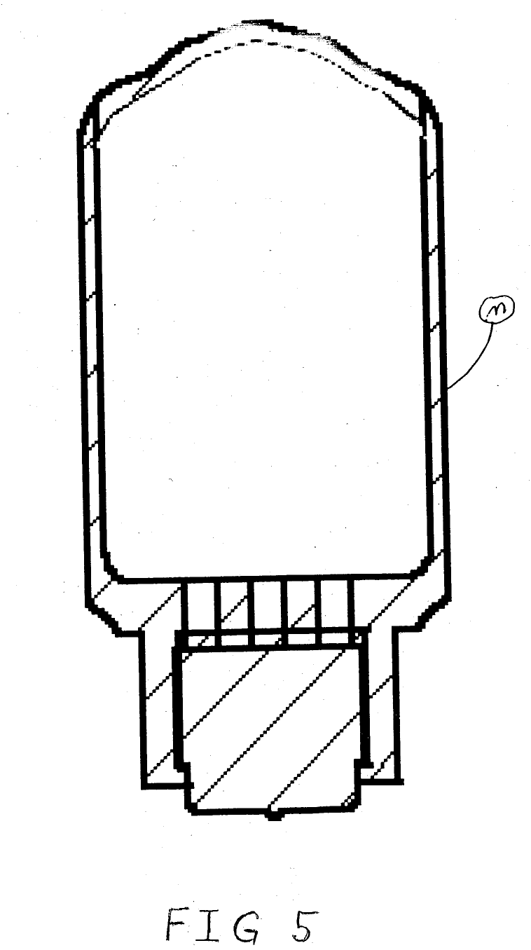

Part (M) is a disposable ink/paint cartridge. The individual components of the part are explained in greater detail in FIG. 5. This part is used to hold the ink or paint to make the actual mark on a surface. The part is placed inside of the cartridge holder (part J) and is held in place by placing the cartridge holder cap (part O) onto the cartridge holder (part J)

Part (N) is a plastic cap which fits onto the top housing (Part D) and is used to hide all the inside components. This cap is removed as the first step of the process of replacing the disposable ink/paint cartridge (Part M) or to add powdered chalk, toner, or powdered lead to the powdered marking material cartridge (Part Q).

Part (O) is a plastic cartridge holder cap. This is used to hold the disposable ink/paint cartridge (part M) in place. This part screws onto the cartridge holder (part J).

Part (P) is a metal self-tapping screw. There are two required for this invention. These parts are to be screwed up through two holes in the bottom housing and into two bosses in the top housing, which are aligned with the holes.

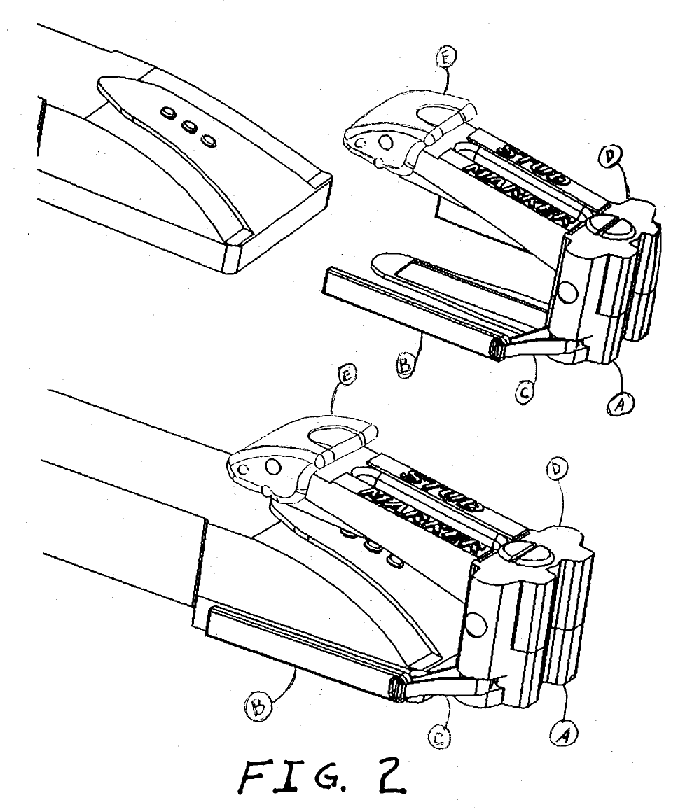

FIG. 2 is showing the incorporation of this invention to a generic referenced only stud-sensing device. This is done by removing the paper from the sticky foam tape, which is on the lower housing (part A) and attaching the assembly to the bottom side of the stud sensor. Once this is done, the paper is removed from the sticky foam tape on each plastic side attachment (part B) and attached to each side of the stud sensor.

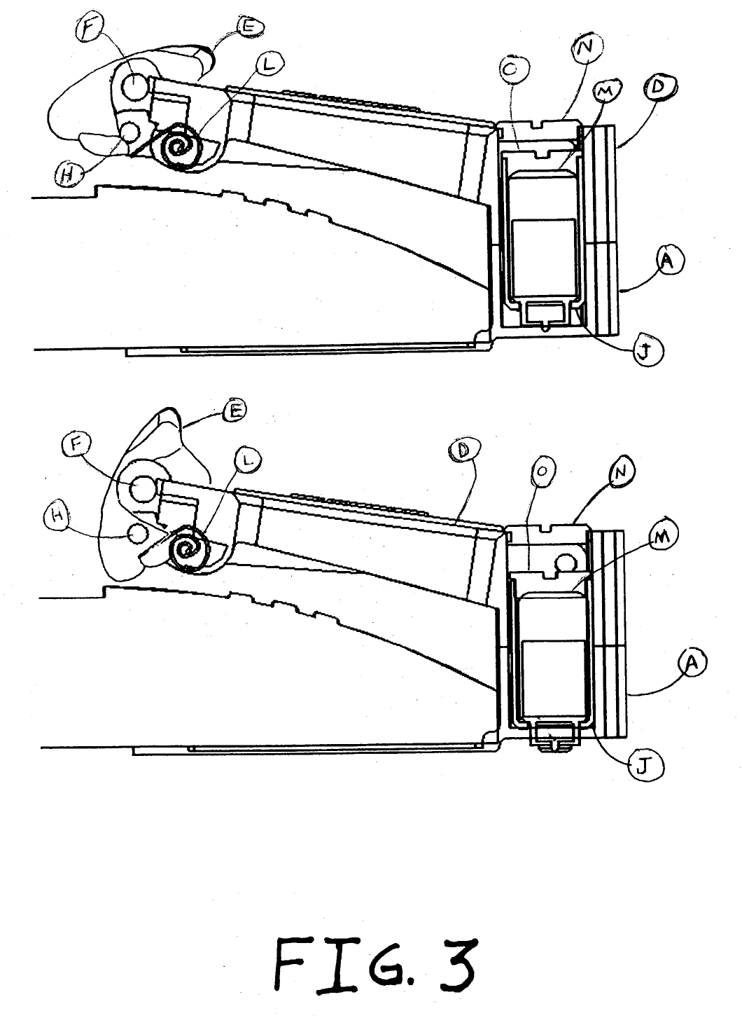

FIG. 3 is showing two side views of a section cut through the assembly of this invention. Part (A) which is the top illustration is showing this related invention attached to a generic referenced only stud sensor in the before activation position thus showing the button in the forward down position and the marker assembly in the up position inside the housing. Part (B) which is the bottom illustration is showing this related invention attached to a generic referenced only stud sensor after activation thus showing the button pulled rearward and the marker assembly in the down position.

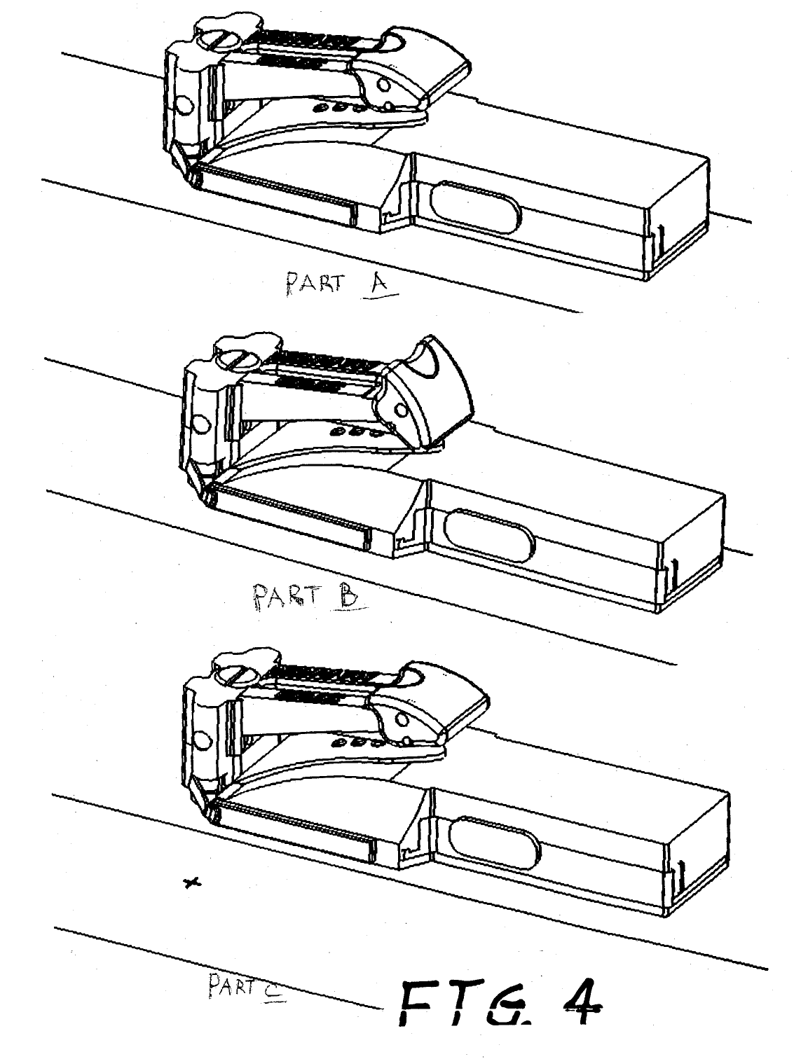

FIG. 4 is showing three isometric views of this inventions assembly connected to a generic referenced only stud-sensing device as to how a person would place a mark on a surface. This figure is separated into three parts. Part (A), which is the top illustration, is showing this invention attached to a generic stud sensor and placed onto a reference only surface and is before activation of this inventions assembly. Part (B), which is the center illustration, is showing this invention attached to a generic stud sensor and placed onto a reference only surface with the button in the rearward activation position. Part (C) which is the bottom illustration is showing this invention attached to a generic stud sensor and showing the above mentioned assembly lifted away from surface and a cross line mark left on that surface thus indicating the desired location to place a screw or nail.

FIG. 5 is showing a side section cut view of the disposable ink cartridge assembly (REF. FIG. 1, part M)

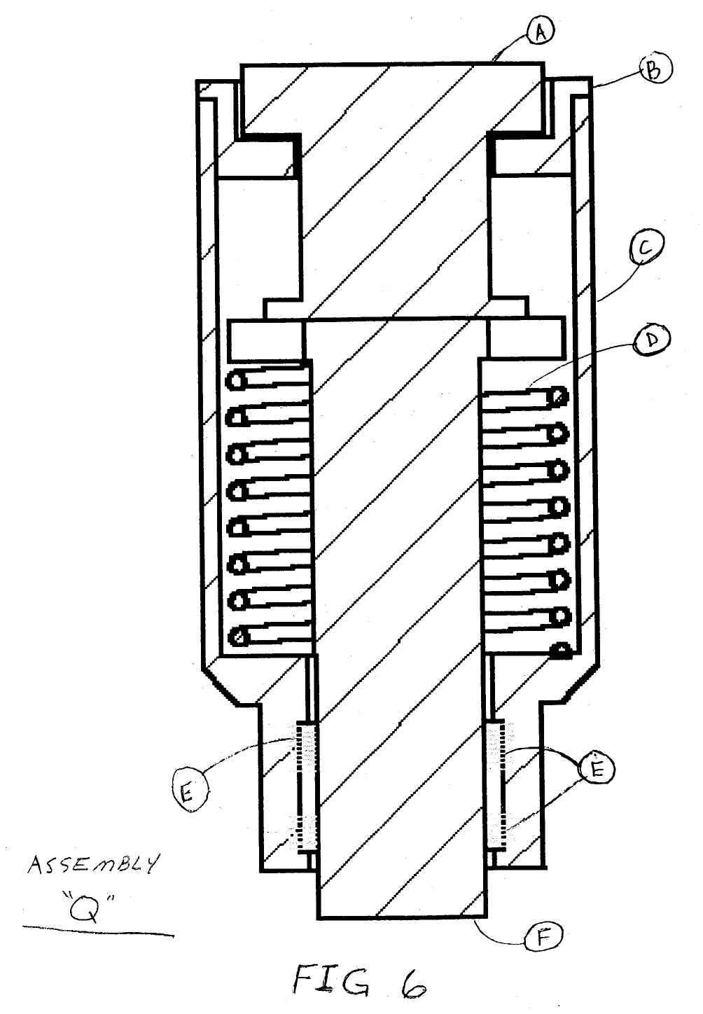

FIG. 6 is showing a side section cut view of the reusable powdered chalk/toner/or lead cartridge. This assembly is used to hold a choice of powdered chalk, powdered lead or toner, which is used to place a mark on a surface.

This assembly slides into the cartridge holder (FIG. 1, part J) and is held in place by the cartridge holder cap (FIG. 1, part O).

Part (A) is a push rod which aids in pushing the stamp (part F) through the applicator brushes (part E)

Part (B) is a top cap which unscrews from the housing (Part C) and is used to add more chalk or toner or powdered lead and is also used to hold the powder inside the housing (Part C)

Part ( C) is a plastic housing used to hold the components of this assembly together and to hold the marking material inside.

Part (D) is a metallic wire wound spring and is used to push the marking device back into the upward position.

Part (E) is an applicator part of the assembly. This can be made from nylon or horsehair and is used to brush the powdered marking material onto the foam stamp (part F) As the foam stamp (part F) passes through them on it's way to making a mark on a surface.

Part (F) is a foam stamp and is used to place a mark on a surface by holding the marking material onto it's surface once it has passed through the applicator (part E)

1. What is claimed as a method and device to place a mark on a surface using either ink, chalk, paint, lead, charcoal, or toner and which this assembly can be added to any existing stud sensor (FIG. 2) by peeling the paper off of the 2-way sticky foam tape which is located on the top side of the lower housing (FIG. 1 part-A) and sticking the assembly to the bottom side of the stud sensor and then peeling the paper off of the side of each side support (FIG. 1 part-B) and sticking each side support (FIG. 1 part-B) to each side of the stud sensor which each side support (FIG. 1 part-B) is then connected to the sides of the lower housing (FIG. 1 part-A) by using an adjustable nylon strap (FIG. 1 part-C) which has Velcro on it to allow for adjustment to a custom fit of the assembly which consists of an upper housing (FIG. 1 part-D), a lower housing (FIG. 1 part-A), a button (FIG. 1 part-E) which is set to pivot on a pin (FIG. 1 part-F) to be located in the upper housing (FIG. 1 part-D) and attaches to two of the same push lever (FIG. 1 part-G) on the right and left underside of the button (FIG. 1 part-E) and both are connected with a pin (FIG. 1 part-H) on the button (FIG. 1 part-E) end and each push lever (FIG. 1 part-G) is then connected to a pivot lever (FIG. 1 part-I) which has an extruded boss on the upper side of the pivot lever (FIG. 1 part-I) that then is located through an open hole at the end of each push lever(FIG. 1 part-G) to actuate each pivot lever (FIG. 1 part-I) once the button (FIG. 1 part-E) is actuated on each side of the center symmetry line and which each pivot lever (FIG. 1 part-I) is connected to the upper housing (FIG. 1 part-D) by having another extruded boss which protrudes out from the pivot lever (FIG. 1 part-I) at the center of rotation location and locates into a hole located in the top housing (FIG. 1 part-D) on each side and as the button (FIG. 1 part-E) is actuated rearward thus moving the push levers (FIG. 1 part-G) forward and rotating both pivot levers (FIG. 1 part-I) to a forward position this causes the lower side of each pivot lever (FIG. 1 part-I) to rotate rearward and glide on the wings of the cartridge holder (FIG. 1 part-J) which are to be set at an angle that will cause the cartridge holder (FIG. 1 part-J) to be pushed down approximately 4 millimeters through the lower housing (FIG. 1 part-A) thus allowing the ink, chalk, charcoal, paint, lead, or toner to be applied to a surface in the shape of a thin line or a thin plus sign and once the mark is left and the button (FIG. 1 part-E) is released the cartridge holder (FIG. 1 part-J) is pushed back in the upward position by 2 springs (FIG. 1 part-K) to be located on the under side of the wings of the cartridge holder (FIG. 1 part-J) and the top surface of the lower housing (FIG. 1 part-A) and the push levers (FIG. 1 part-G) are pulled back into position simultaneously by a spring (FIG. 1 part-L) to be located in the upper housing (FIG. 1 part-D) near the rear by the button (FIG. 1 part-E) thus pulling each push lever (FIG. 1 part-G) back into position thus pulling the button (FIG. 1 part-E) back into the down position and once the ink, paint, chalk, lead or toner cartridge (FIG. 1 part-M) runs dry, the cartridge (FIG. 1 part-J) can then be replaced by removing the top housing cap (FIG. 1 part-N) from the top housing (FIG. 1 part-D) and then removing the cartridge holder cap (FIG. 1 part-O) from the cartridge holder (FIG. 1 part-J) and removing the old empty cartridge (FIG. 1 part-M) from the cartridge holder (FIG. 1 part-J) through the hole located in the top housing (FIG. 1 part-D) and replacing the old cartridge (FIG. 1 part-M) with a new full cartridge (FIG. 1 part-M) and then lock it into position by replacing the cartridge holder cap (FIG. 1 part-O) back into the cartridge holder (FIG. 1 part-J) and then replacing the top housing cap (FIG. 1 part-N) back onto the top housing (FIG. 1 part-D)
